(19) United States
(12) Patent Application Publication
(10) Pub. No.: US 2015/0288498 A1
(43) Pub. Date: Oct. 8, 2015

(54) Upstream Transmission Burst Configuration

(71) Applicant: Broadcom Corporation, Irvine, CA (US)

(72) Inventors: Avi Kliger, Ramat Gan (IL); Anatoli Shindler, Qiryat Ono (IL); Yitshak Ohana, Givat Zeev (IL); Eliahu Shusterman, kfar-Saba (IL)

(73) Assignee: Broadcom Corporation, Irvine, CA (US)

(21) Appl. No.: 14/678,075

(22) Filed: Apr. 3, 2015

Related U.S. Application Data
(60) Provisional application No. 61/974,944, filed on Apr. 3, 2014.

(51) Int. Cl. H04L 5/00; H04J 1/02

(52) U.S. Cl. CPC H04L 5/0048; H04J 1/02

(57) ABSTRACT

The present disclosure is directed to an apparatus and method for processing data for upstream transmission. The apparatus and method can be implemented within a cable modem to specifically process data for upstream transmission over a hybrid fiber coaxial (HFC) network to a cable modem termination system in accordance with parameters in an upstream profile. The upstream profile can be specified by the cable modem termination system.

### CROSS REFERENCE TO RELATED APPLICATIONS

This application claims the benefit of U.S. Provisional Patent Application No. 61/974,944, filed Apr. 3, 2014, which is incorporated by reference herein.

### TECHNICAL FIELD

This application relates generally to upstream transmissions, including upstream transmissions in cable modem communication systems.

### BACKGROUND

Cable modem communication systems include a cable modem termination system, cable modems, and a cable modem network plant (e.g., hybrid fiber-coaxial media) that communicatively couples the cable modem termination system and the cable modems. The Data Over Cable Service Interface Specification (DOCSIS) typically governs the transmission and reception of signals in a cable modem communication system.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates an example cable modem system.

FIG. 2 illustrates an example portion of an upstream frame in accordance with embodiments of the present disclosure.

FIGS. 3A-3F illustrate example minislot pilot patterns in accordance with embodiments of the present disclosure.

FIG. 4 illustrates an example block diagram of an upstream receiver that can be implemented in a cable modem in accordance with embodiments of the present disclosure.

FIG. 5 illustrates a flowchart of an example method for processing data for upstream transmission in accordance with embodiments of the present disclosure.

FIG. 6 illustrates a block diagram of an example computer system that can be used to implement aspects of the present disclosure.

The embodiments of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### I. OVERVIEW

The present disclosure is directed to an apparatus and method for processing data for upstream transmission. In one embodiment, the data is processed by an upstream transmitter of a cable modem for upstream transmission over a hybrid fiber coaxial (HFC) network to a cable modem termination system in accordance with parameters in an upstream profile. In another embodiment, the upstream profile is specified by the cable modem termination system. These and other features of the present disclosure are described further below.

### II. EXAMPLE OPERATING ENVIRONMENT

In an exemplary cable modem communication system in which embodiments of the present disclosure can be implemented, a cable modem termination system is located at a cable operator's facility and functions to serve a large number of subscribers. The cable modem communication system can operate in accordance with, for example, version 3.1 of the Data Over Cable Service Interface Specification (DOCSIS). In the cable modem communication system, each subscriber has a cable modem and the cable modem termination system is capable of communicating bi-directionally with the cable modems. A typical cable modem termination system includes a burst receiver, a continuous transmitter a medium access control (MAC), and upper layer functionalities.

The cable modem termination system can communicate with the cable modems via a hybrid fiber coaxial (HFC) network. The HFC network utilizes a point-to-multipoint topology to facilitate communication between the cable modem termination system and the cable modems. HFC networks are commonly utilized by cable providers to provide Internet access, cable television, voice services and the like to the subscribers associated with the cable modems. Frequency domain multiplexing (FDM) combined with time division multiplexing (TDM) may be used to facilitate communication from the cable modem termination system to the cable modems, i.e., in the downstream direction. FDM can be accomplished using orthogonal sub-carriers, as in orthogonal frequency division multiplexing (OFDM), and/or using non-orthogonal sub-carriers with adequate spacing in the frequency domain. Frequency domain multiple access (FDMA) combined with time domain multiple access (TDMA) is used to facilitate communication from the cable modems to the cable modem termination system, i.e., in the upstream direction. FDMA can similarly be accomplished using orthogonal sub-carriers, as in orthogonal frequency division multiple access (OFDMA), and/or using non-orthogonal sub-carriers with adequate spacing in the frequency domain.

The cable modem termination system includes a downstream modulator for facilitating the transmission of data communications to the cable modems and an upstream demodulator for facilitating the reception of data communications from the cable modems. The downstream modulator of the cable modem termination system can use, for example, 64 QAM all the way up to 4096 QAM in an approximate frequency range of 250 MHz to 1.2 GHz to provide a data rate up to and beyond 10 Gbps. The upstream demodulator can use, for example, 64 QAM all the way up to 1024 QAM in an approximate frequency range of 5 MHz to 200 MHz to provide a data rate up to and beyond 1 Gbps. Optional support for 8192 QAM and 16384 QAM on the downstream and 2048 QAM and 4096 QAM on the upstream are also possible. Similarly, each cable modem includes an upstream modulator for facilitating the transmission of data to the cable modem termination system and a downstream demodulator for receiving data from the cable modem termination system.

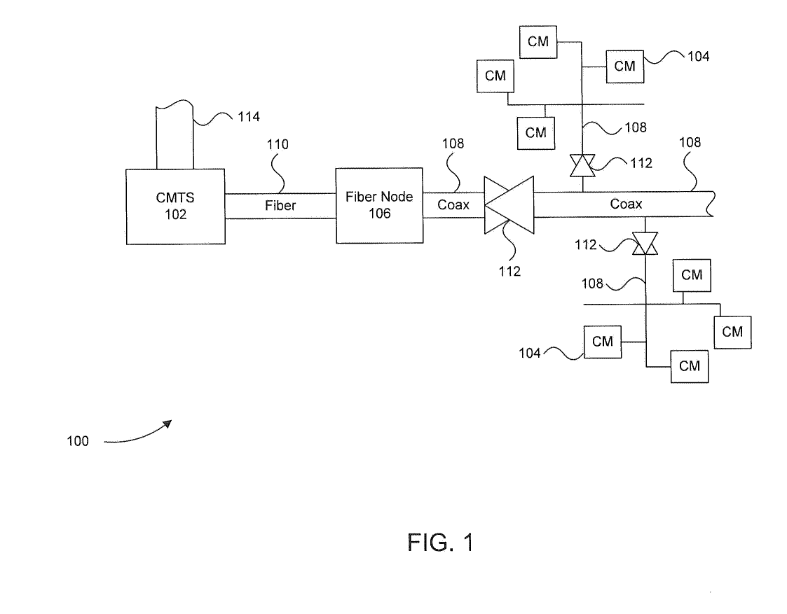

Referring now to FIG. 1, an exemplary cable modem communication system 100 that provides for the transmission of data between a cable modem termination system (CMTS) 102 and a number of cable modems (CMs) 104 using a HFC network as described above is shown. Cable modem communication system 100 can specifically operate in accordance with DOCSIS 3.1.

As shown in FIG. 1, cable modems 104 are in electrical communication with a fiber node 106 via coaxial cables 108. Amplifiers 112 can be used to facilitate the electrical connection of, for example, the more distant cable modems 104 to the fiber node 106 by boosting their electrical signals to enhance the signal-to-noise ratio of such communications. Fiber node 106 is further in communication with cable modem termination system 102 via optical fiber 110 and can perform the necessary electrical to optical and optical to electrical conversions between coaxial cables 108 and optical fiber 110 to facilitate the transfer of data. Cable modem termination system 102 communicates via transmission line 114 with the Internet, one or more headends, and/or any other desired device(s) or network(s) to provide various services to the subscribes associated with cable modems 104.

### II. UPSTREAM TRANSMISSION BURST CONFIGURATION

In order to accomplish upstream communication in a cable modem communication system, such as those described above, time and frequency slots referred to as minislots that make up an upstream frame may be assigned to one or more cable modems having a message to send to the cable modem termination system. The assignment of such minislots can be accomplished by providing a request contention area in the upstream data path within which the cable modems are permitted to contend in order to place a message to request time in the upstream data path for the transmission of their messages. The cable modem termination system responds to these requests by assigning minislots in a transmission burst to each cable modem so that the cable modems can transmit their messages to the cable modem termination system utilizing OFDMA and so that the transmissions are performed without undesirable collisions. The assignments are generally sent by the cable modem termination system in a grant message.

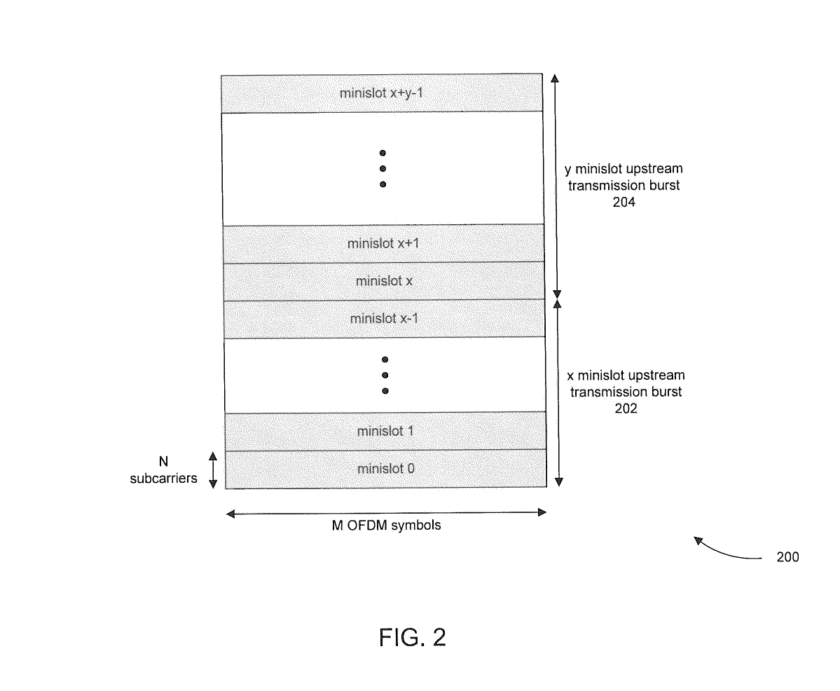

FIG. 2 illustrates an exemplary portion of an upstream frame 200 that can be used to carry upstream transmissions from cable modems to a cable modem termination system, such as cable modems 104 and cable modem termination system 102 described above, in accordance with embodiments of the present disclosure. The portion of upstream frame 200 shown in FIG. 2 shows two upstream transmission bursts 202 and 204. Upstream transmission burst 202 includes x minislots and upstream transmission burst 204 includes y minislots, where x and y are integer values. Each minislot occupies the full upstream frame time and a different group of sub-carriers. For example, minislot 0 includes the N sub-carriers at the bottom of the portion of upstream frame 200 shown in FIG. 2, where N is an integer value. The upstream frame time can include a configurable number of OFDM symbols M, where M is an integer value.

As described above, a cable modem is assigned by a cable modem termination system via a grant message to transmit upstream over the minislots in an upstream transmission burst, such as upstream transmission burst 202 or 204. The grant message from the cable modem termination system indicates which minislots are assigned to a given transmission burst and which of multiple, available upstream profiles is to be used for each minislot or group of minislots in a transmission burst. An upstream profile defines how information in a minislot will be transmitted upstream from a cable modem to the cable modem termination system. An upstream profile can be selected for a minislot to increase the reliability at which information is transmitted over the minislot and/or increase the amount of information that is able to be transmitted over the minislot.

For example, a cable modem termination system may select an upstream profile for minislot 0 in FIG. 2 that assigns a high modulation order (or bit-loading) to the sub-carriers of minislot 0 based on the sub-carriers having high, associated signal-to-noise ratios (SNRs). On the other hand, the cable modem termination system may select a profile for minislot 1 that assigns a comparatively lower modulation order to the sub-carriers of minislot 1 based on the sub-carriers having low, associated SNRs.

In one embodiment, the upstream profiles have three groups of parameters: upstream OFDM block parameters, burst parameters, and user unique parameters. The cable modem termination system can define these parameters for multiple profiles and communicate the parameter values of the multiple profiles to the cable modems.

Upstream OFDM block parameters relate to or include, for example, the spacing between sub-carriers in an OFDM symbol (e.g., 25 kHz or 50 kHz), cyclic prefix and windowing requirements, band-edge exclusion sub-carriers (hi-side and low-side), and/or mini-slot dimensions (e.g., the minislot duration time in terms of a number of OFDM symbols and the number of sub-carriers in the minislot). A cyclic prefix is a segment at the end of an OFDM symbol that is prepended to the OFDM symbol, whereas windowing refers to time domain shaping of the OFDM symbols. Windowing is applied at the beginning and end of an OFDM symbol. Band-edge exclusion sub-carriers refer to excluded sub-carriers outside of a minislot. In one embodiment, excluded sub-carriers are common to all cable modems that transmit upstream on the same upstream channel. An excluded sub-carrier is a sub-carrier that cannot be used because another type of service or permanent ingressor is present on the sub-carrier. In one embodiment, excluded sub-carriers are not part of any minislot.

Burst parameters relate to or include, for example, the modulation order (or bit-loading) of the sub-carriers within a minislot and/or the type of forward error correction (FEC) code (e.g., long, medium, or short FEC code) to be used to protect the information carried by the sub-carriers of the minislot. The modulation order can be, for example, anywhere between (and including) 2 QAM (QPSK) to 4096 QAM. In one embodiment, all sub-carriers within a minislot (except those carrying complimentary pilots as explained further below) have the same modulation order. However, each minislot within an upstream transmission burst can have a different modulation order.

User unique parameters relate to or include, for example, upstream transmit power, upstream timing adjustments, and/or upstream pre-equalization parameters.

Also, as part of the burst parameters in an upstream profile, one of several different available pilot patterns can be specified for a minislot associated with the upstream profile or for each minislot in an upstream transmission burst associated with the upstream profile. A pilot pattern defines the number and arrangement of pilots in a minislot. There are two types of pilots: normal pilots (or simply pilots) that are pre-defined binary phase-shift keying (BPSK) symbols, and complimentary (or low density) pilots that are IQ-symbols that carry data but with a lower modulation order than the other IQ-symbols that carry data in the minislot. The cable modem termination system receiver uses the pilots transmitted upstream from a cable modem to, for example, estimate and adapt parameters to upstream channel conditions and to estimate and adjust for frequency offset. Frequency offset can specifically be estimated by measuring phase differences between pilot symbols.

Several pilot patterns can be defined within the communication specification used by a cable modem communication system, such as cable modem communication system 100 shown in FIG. 1, and each could be identified in an upstream burst profile by a unique pattern number. The pilot patterns differ by number of pilots in a minislot and/or the specific arrangement of pilots within a minislot. A specific pilot pattern from those available can be selected for a minislot based on the position of the minislot within an upstream transmission burst, based on channel conditions (e.g., frequency response or SNR) associated with the minislot, and/or based on whether pre-equalization is performed by the cable modem to pre-equalize the sub-carriers of the upstream minislot.

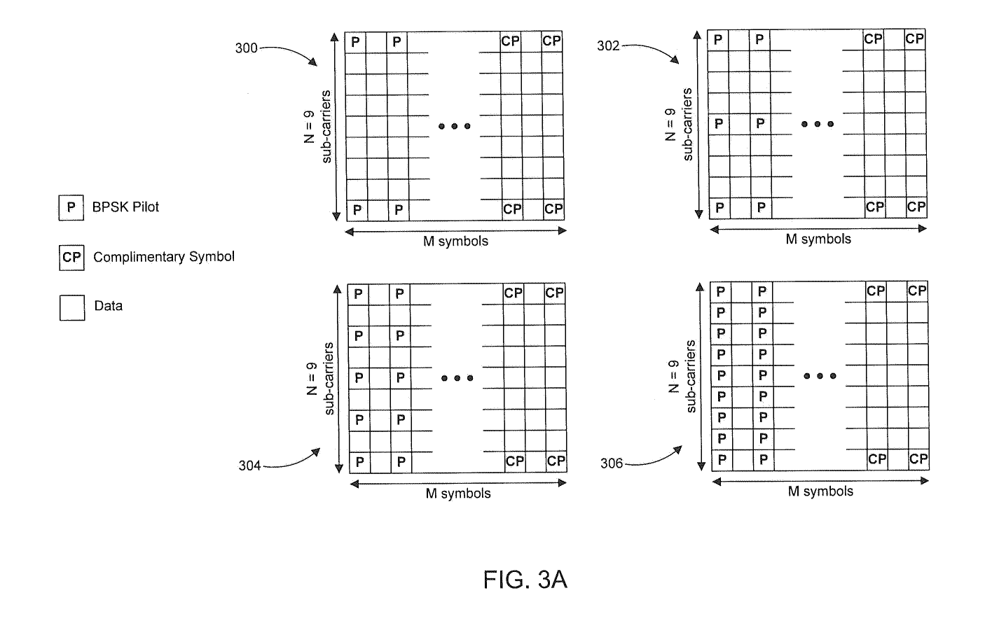

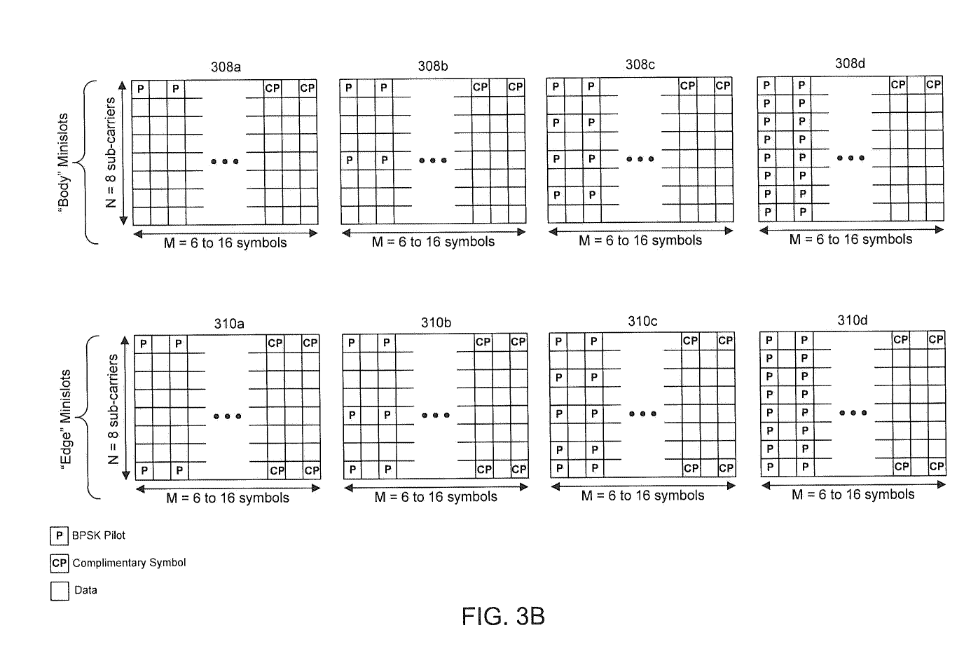

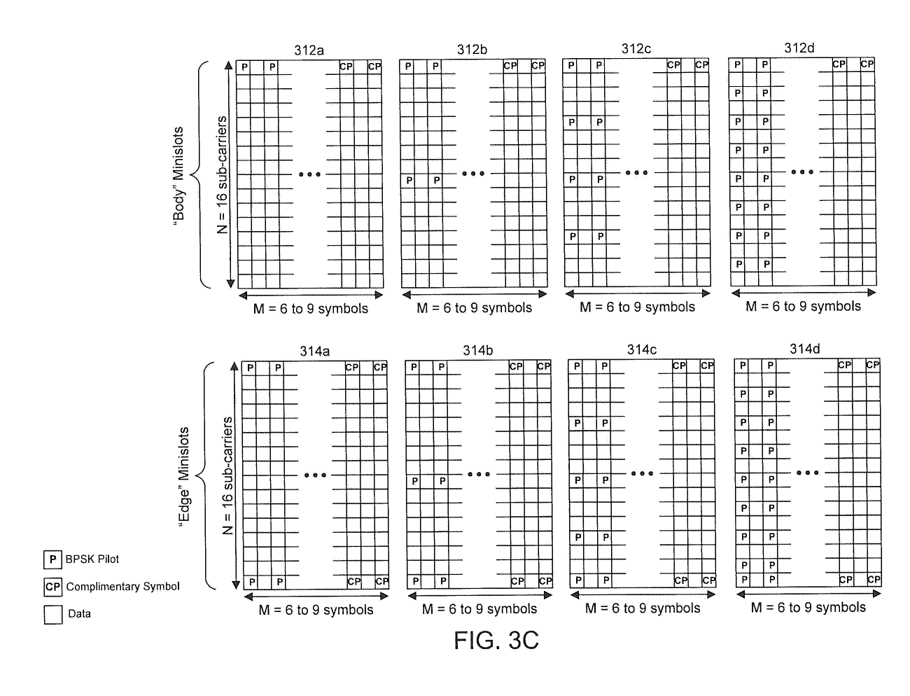

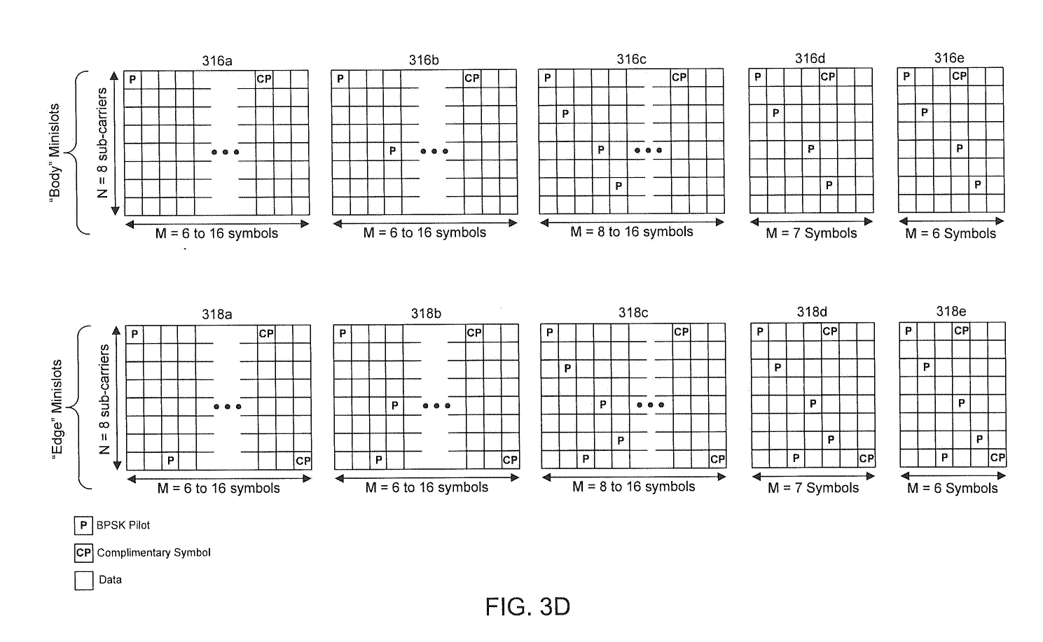

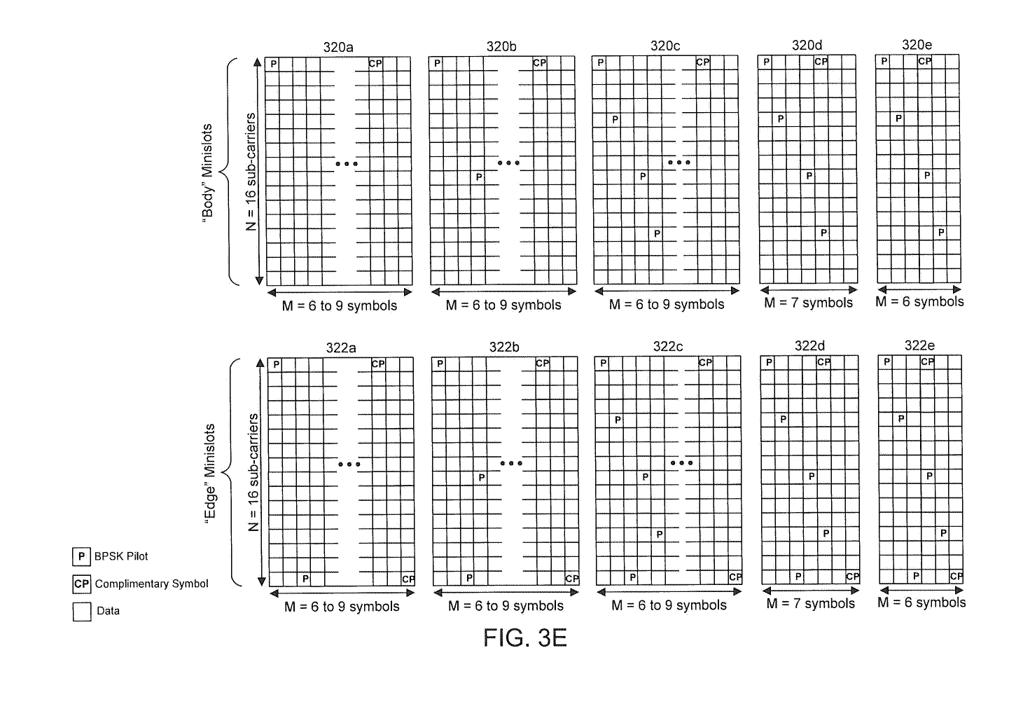

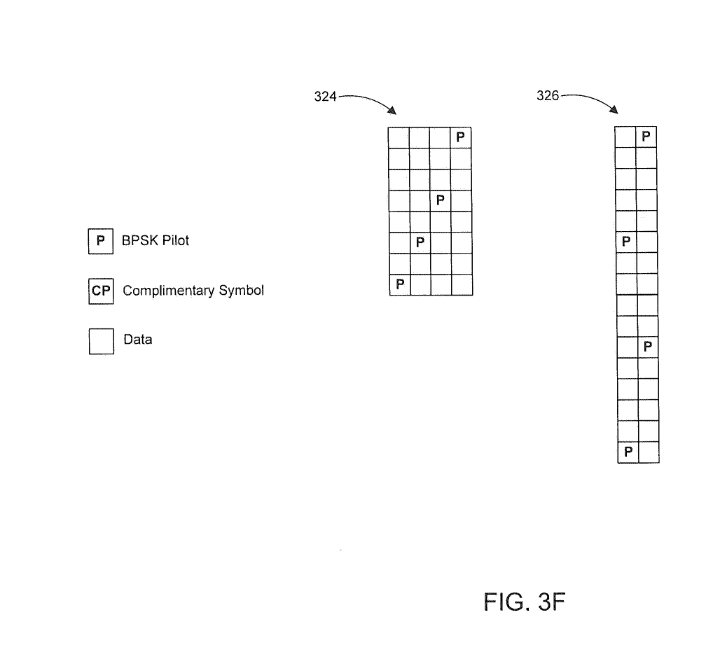

If, for example, pre-equalization is performed by the cable modem to pre-equalize the sub-carriers of an upstream minislot, the cable modem termination system may specify in the upstream burst profile a pilot pattern for the minislot that has fewer pilots and greater spacing between pilots in the frequency domain than if no pre-equalization is performed by the cable modem. In addition, for the first minislot in an upstream transmission burst (“edge” minislot), the cable modem termination system may specify in the upstream burst profile a pilot pattern for the minislot that has more pilots and less spacing between pilots in the frequency domain than other minislots in the upstream transmission burst (“body” minislots) to improve channel estimation and frequency offset tracking. Channel estimation on sub-carriers without pilots may be improved if each burst starts and ends with pilots. In one embodiment, there can be separate pilot patterns defined within the communication specification used by a cable modem communication system for “edge” minislots and “body” minislots. The pilot patterns defined for “edge” minislots can also be used for the first minislot of an upstream frame (where, for example, a transmission burst extends between two upstream frames) and for the first minislot after an exclusion band. FIG. 3A illustrates four exemplary minislot pilot patterns 300, 302, 304, and 306 in accordance with embodiments of the present disclosure. Each square in minislot pilot patterns 300, 302, 304, and 306 represents a sub-carrier at a specific symbol time. BPSK pilots are denoted by “P” and complimentary pilots are denoted by “CP”. All other empty squares in minislot pilot patterns 300, 302, 304, and 306 carry data with the modulation order (or bit-loading) specified for the minislot in the minislot's associated upstream profile.

Each of minislot pilot patterns 300, 302, 304, and 306 illustrates a pilot pattern that uses a different BPSK pilot sub-carrier spacing configuration. In particular, minislot pilot pattern 300 has a BPSK pilot on every 8^{th} sub-carrier of the first and third OFDM symbols of the minislot, minislot pilot pattern 302 has a BPSK pilot on every 4^{th} sub-carrier of the first and third OFDM symbols of the minislot, minislot pilot pattern 304 has a BPSK pilot on every 2^{nd} sub-carrier of the first and third OFDM symbols of the minislot, and minislot pilot pattern 306 has a BPSK pilot on every sub-carrier of the first and third OFDM symbols of the minislot.

Complimentary pilot symbols can be positioned in sub-carriers of the last and third to last OFDM symbols of the minislot. Minislot pilot patterns 300, 302, 304, and 306 illustrate an exemplary number and sub-carrier positioning of complimentary pilot symbols within the last and third to last OFDM symbols of minislots. As will be appreciated by one of ordinary skill in the art, more or less complimentary pilot symbols and other sub-carrier positions within the last and third to last OFDM symbols of minislots can be used.

As will be further appreciated by one of ordinary skill in the art, the different BPSK pilot sub-carrier spacing configurations shown in FIG. 3A can be applied to minislots of different sizes. For example, although all of minislot pilot patterns 300, 302, 304, and 306 in FIG. 3A are shown in minislots that have 9 sub-carriers, the different sub-carrier spacing configurations of BPSK pilots illustrated by minislot pilot patterns 300, 302, 304, and 306 can be applied, at least in part, to minislots with more or less sub-carriers as described further below with respect to FIGS. 3B and 3C.

FIG. 3B illustrates four minislot pilot patterns 308a-308d in minislots that each have 8 sub-carriers in accordance with embodiments of the present disclosure. Minislot pilot pattern 308a uses the BPSK pilot sub-carrier spacing configuration of a BPSK pilot on every 8^{th} sub-carrier of the first and third OFDM symbols of the minislot, minislot pilot pattern 308b uses the BPSK pilot sub-carrier spacing configuration of a BPSK pilot on every 4^{th} sub-carrier of the first and third OFDM symbols of the minislot, minislot, pilot pattern 308c uses the BPSK pilot sub-carrier spacing configuration of a BPSK pilot on every 2^{nd} sub-carrier of the first and third OFDM symbols of the minislot, and minislot pilot pattern 308d uses the BPSK pilot sub-carrier spacing configuration of a BPSK pilot on every sub-carrier of the first and third OFDM symbols of the minislot.

In one embodiment, minislot pilot patterns 308a-308d can be specifically defined within a communication specification used by a cable modem communication system for “body” minislots and a separate set of minislot pilot patterns 310a-310d can be defined within the communication specification for “edge” minislots. Minislot pilot patterns 310a-310d can use the same pilot pattern configurations as minislot pilot patterns 308a-308d but with the addition of BPSK pilots and complimentary pilots in the last sub-carrier of particular OFDM symbols in the minislots as shown in FIG. 3B.

It should be noted that FIG. 3B shows minislot pilot patterns 308a-308d and 310a-310d for M=6 to 16 OFDM symbols. For M greater than 16, the complimentary pilots can remain in the 14^{th} and 16^{th} OFDM symbols and all other OFDM symbols from 17 to the end of the frame can carry only data.

FIG. 3C illustrates four minislot pilot patterns 312a-312d in minislots that each have 16 sub-carriers in accordance with embodiments of the present disclosure. Minislot pilot pattern 312a uses a BPSK pilot sub-carrier spacing configuration of a BPSK pilot on every 16^{th} sub-carrier of the first and third OFDM symbols of the minislot, minislot pilot pattern 312b uses the BPSK pilot sub-carrier spacing configuration of a BPSK pilot on every 8^{th} sub-carrier of the first and third OFDM symbols of the minislot, minislot pilot pattern 312c uses the BPSK pilot sub-carrier spacing configuration of a BPSK pilot on every 4^{th} sub-carrier of the first and third OFDM symbols of the minislot, and minislot pilot pattern 312d uses the BPSK pilot sub-carrier spacing configuration of a BPSK pilot on every 2^{nd} sub-carrier of the first and third OFDM symbols of the minislot.

In one embodiment, minislot pilot patterns 312a-312d can be specifically defined within a communication specification used by a cable modem communication system for “body” minislots and a separate set of minislot pilot patterns 314a-314d can be defined within the communication specification for “edge” minislots. Minislot pilot patterns 314a-314d can use the same pilot pattern configurations as minislot pilot patterns 312a-312d but with the addition of BPSK pilots and complimentary pilots in the last sub-carrier of particular OFDM symbols in the minislots as shown in FIG. 3C.

FIG. 3D illustrates four additional minislot pilot patterns 316a-316d for “body” minislots and four additional minislot pilot patterns 318a-318d for “edge” minislots. Minislot pilot patterns 316a-316d and 318a-318d can respectively be used as alternatives to minislot pilot patterns 308a-308d and 310a-310d in FIG. 3B, which use more pilots. In one embodiment, to make up for the decrease in pilots, the power at which the pilots used in minislot pilot patterns 316a-316d and 318a-318d can be transmitted by cable modems with boosted power (e.g., by 4.4 dB) as compared to the pilots used in minislot pilot patterns 308a-308d and 310a-310d. In one embodiment, not all complimentary pilots are boosted in power.

It should be noted that FIG. 3D shows minislot pilot patterns 316a-316c and 318a-318c for M up to 16 OFDM symbols. For M greater than 16, the complimentary pilots can remain in the 14^{th} OFDM symbol and 16^{th} OFDM symbol (for “edge” minislots) and all other OFDM symbols from 17 to the end of the frame can carry only data.

Similar to FIG. 3C, FIG. 3E illustrates four additional minislot pilot patterns 320a-320d for “body” minislots and four additional minislot pilot patterns 320a-320d for “edge” minislots. Minislot pilot patterns 320a-320d and 322a-322d can respectively be used as alternatives to minislot pilot patterns 312a-312d and 314a-314d in FIG. 3C, which use more pilots. In one embodiment, to make up for the decrease in pilots, the power at which the pilots used in minislot pilot patterns 320a-320d and 322a-322d can be transmitted by cable modems with boosted power (e.g., by 4.4 dB) as compared to the pilots used in minislot pilot patterns 312a-312d and 314a-314d. In one embodiment, not all complimentary pilots are boosted in power.

Referring now to FIG. 3F, two additional subslot pilot patterns 324 and 326 are shown. In general, a minislot can be subdivided in time into multiple subslots. Subslots provide transmission opportunities for cable modems to request upstream bandwidth via a REQ message. REQ messages are 56-bits long and use QPSK modulation. Subslot pilot patterns can be further defined by a parameter in an upstream profile.

Subslot pilot pattern 324 is shown for a subslot with 8 sub-carriers and 4 OFDM symbols. There are a total of 4 BPSK pilots in subslot pilot pattern 324, each of which may be boosted as described above in regard to FIGS. 3D and 3E above.

Subslot pilot pattern 326 is shown for a subslot with 16 sub-carriers and 2 OFDM symbols. There are a total of 4 BPSK pilots in subslot pilot pattern 326, each of which may be boosted as described above in regard to FIGS. 3D and 3E above.

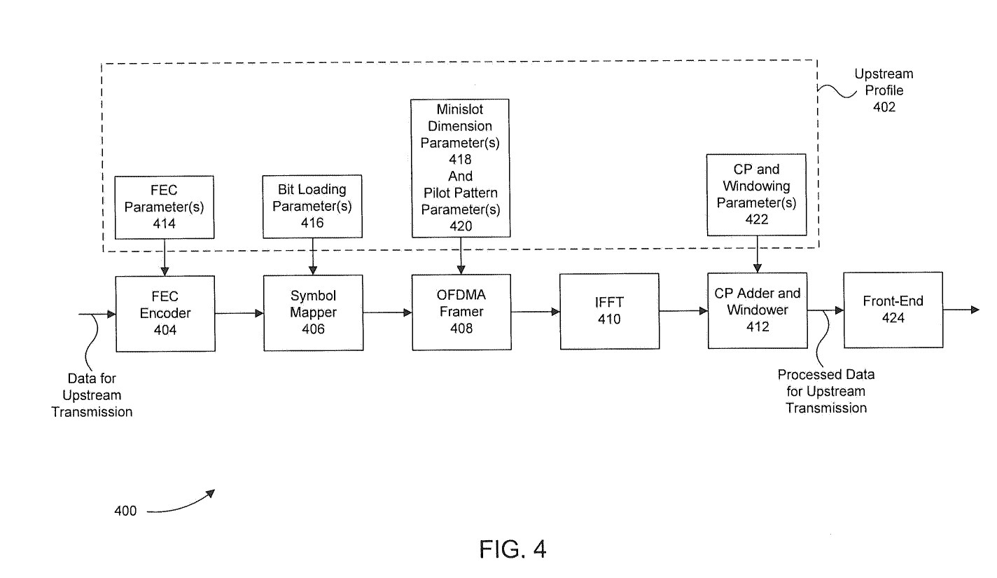

Referring now to FIG. 4, an example upstream transmitter 400 that can be used by a cable modem, such as cable modems 104 described above in regard to FIG. 1, to transmit data upstream in accordance with embodiments of the present disclosure is illustrated. Upstream transmitter 400 specifically receives data to be transmitted upstream and processes the data for upstream transmission in one or more assigned minislots of an upstream transmission burst. The data is specifically processed for upstream transmission in the one or more assigned minislots of an upstream transmission burst in accordance with an associated upstream profile 402. As described above, the minislots of an upstream transmission burst and the upstream profile associated with the minislots of the upstream transmission burst can be assigned to a cable modem by a cable modem termination system in a grant message.

As shown in FIG. 4, upstream transmitter 400 includes a FEC encoder 404, a symbol mapper 406, an OFDMA framer 408, an inverse fast Fourier transform (IFFT) 410, and a cyclic prefix adder and windower 412. It should be noted that upstream transmitter 400 can include additional processing blocks other than those shown in FIG. 4. For example, upstream transmitter 400 can further include, in other embodiments, a scrambler, interleaver, and/or pre-equalizer.

In operation, FEC encoder 404 receives the input data to be transmitted upstream and adds redundancy to the data using a FEC code, such as a low density parity check (LDPC) code. In one embodiment, FEC encoder 402 specifically encodes the input data based on FEC parameter(s) 414 in upstream profile 402. FEC parameter(s) 414 can specify the length of the LDPC code to be used (e.g., long, medium, or short FEC code).

The FEC encoded bits are then mapped to complex symbols (e.g., QAM symbols). In one embodiment, the modulation order (or bit-loading) of the complex symbols is determined based on bit loading parameter(s) 416 in upstream profile 402. The modulation order can be, for example, anywhere between (and including) 64 QAM (or 6-bits per symbol) to 1024 QAM (or 10-bits per symbol). In one embodiment, all sub-carriers within a minislot (except those carrying complimentary pilots) have the same modulation order. However, each minislot within an upstream transmission burst can have a different modulation order as specified by bit-loading parameter(s) 416 in upstream profile 402.

OFDMA framer 408 subsequently places the complex symbols from symbol mapper 406 in the sub-carriers of the assigned transmission burst minislots. In one embodiment, the complex symbols are placed in the sub-carriers of the assigned transmission burst minislots based on minislot dimension parameter(s) 418 in upstream profile 402. Minislot dimension parameters specify the duration of one or more of the minislots in terms of a number of OFDM symbols and/or the number of sub-carriers in one or more of the minislots. In one embodiment, the complex symbols are placed along the time domain, sub-carrier after sub-carrier, to provide time-domain interleaving, or along the time domain but with interleaved sub-carriers to provide time and frequency domain interleaving. Interleaving can be used to improve FEC decoder performance with burst noise and narrowband noise. The OFDMA framer 408 also places pilots in each of the assigned transmission burst minislots based on pilot patterns. In one embodiment, OFDMA framer 408 uses a specific pilot pattern for each of the assigned transmission burst minislots as specified by pilot pattern parameter(s) 420 in upstream profile 402. The pilot patterns can have the same or similar configurations and properties as those described above in regard to FIGS. 3A-3F.

IFFT 410 transforms the OFDM symbols in the upstream transmission burst minislots received from OFDMA framer 408 into the time domain by performing the inverse fast Fourier transform. Inputs of IFFT 410 (or sub-carriers) that are not used can be set to zero.

CP adder and windower 412 perform cyclic prefix addition and windowing on the serialized time domain samples of each OFDM symbol provided by IFFT 410. As mentioned above, a cyclic prefix is a segment at the end of an OFDM symbol that is prepended to the OFDM symbol, whereas windowing refers to a segment at the beginning of an OFDM symbol that is appended at the end of the OFDM symbol. In one embodiment, CP adder and windower 412 uses CP and windowing parameter(s) 422 in upstream profile 402 to determine the length of the segments used for cyclic prefix addition and windowing. The output of CP adder and windower 412 represents processed data that can be transmitted upstream after up-conversion and potentially other final processing steps. For example, a front-end 424 can up-convert, filter, and amplify the processed data before transmitting the processed data upstream. Front-end 424 can include, for example, a mixer, filter, and amplifier.

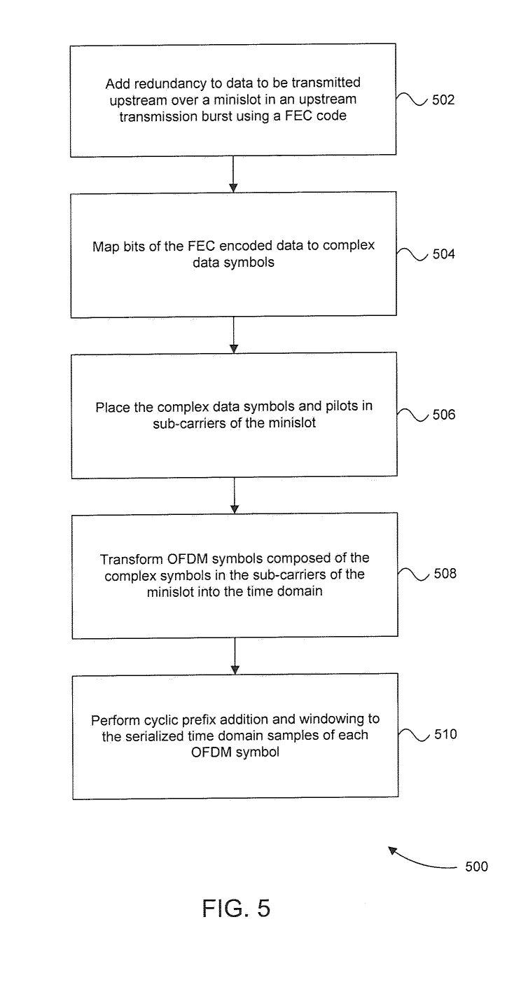

FIG. 5 illustrates a flowchart 500 of an example method for processing data for upstream transmission in accordance with embodiments of the present disclosure. The method of flowchart 500 can be implemented by upstream transmitter 400 as described above and illustrated in FIG. 4. However, it should be noted that the method can be implemented by other systems and components as well.

The method of flowchart 500 begins at step 502. At step 502, redundancy is added to data to be transmitted upstream over a minislot in an upstream transmission burst using a FEC code, such as LDPC. In one embodiment, the data is encoded based on a FEC parameter in an upstream profile associated with the minislot. The FEC parameter can include the length of the LDPC code to be used (e.g., long, medium, or short FEC code).

After step 502, the method of flowchart 500 proceeds to step 504. At step 504, bits of the FEC encoded data are mapped to complex data symbols (e.g., QAM symbols). In one embodiment, the modulation order (or bit-loading) of the complex symbols is determined based on a bit loading parameter in the upstream profile associated with the minislot. The modulation order can be, for example, anywhere between (and including) 64 QAM (or 6-bits per symbol) to 1024 QAM (or 10-bits per symbol). In one embodiment, all sub-carriers within the minislot (except those carrying complimentary pilots) have the same modulation order.

After step 504, the method of flowchart 500 proceeds to step 506. At step 506, the complex data symbols and pilots are placed in sub-carriers of the minislot. In one embodiment, the complex symbols are placed in the sub-carriers of the minislot based on a minislot dimension parameter in the upstream profile associated with the minislot. The minislot dimension parameter can specify the duration of the minislot in terms of a number of OFDM symbols and/or the number of sub-carriers in the minislot. In another embodiment, the pilots are placed in the sub-carriers of the minislot in accordance with a specific pilot pattern specified by a pilot pattern parameter in the upstream profile associated with the minislot.

After step 506, the method of flowchart 500 proceeds to step 508. At step 508, OFDM symbols composed of the complex symbols in the sub-carriers of the minislot are transformed into the time domain using an inverse fast Fourier transform.

After step 508, the method of flowchart 500 proceeds to step 510. At step 510, cyclic prefix addition and windowing are performed on the serialized time domain samples of each OFDM symbol. In one embodiment, the length of the segments used for cyclic prefix addition and windowing are determined based on a CP and windowing parameter in the upstream profile associated with the minislot. After the cyclic prefix addition and windowing is performed, the time domain OFDM symbols can be transmitted upstream after up-conversion and potentially other final processing steps.

### IV. EXAMPLE COMPUTER SYSTEM ENVIRONMENT

It will be apparent to persons skilled in the relevant art(s) that various elements and features of the present disclosure, as described herein, can be implemented in hardware using analog and/or digital circuits, in software, through the execution of instructions by one or more general purpose or special-purpose processors, or as a combination of hardware and software.

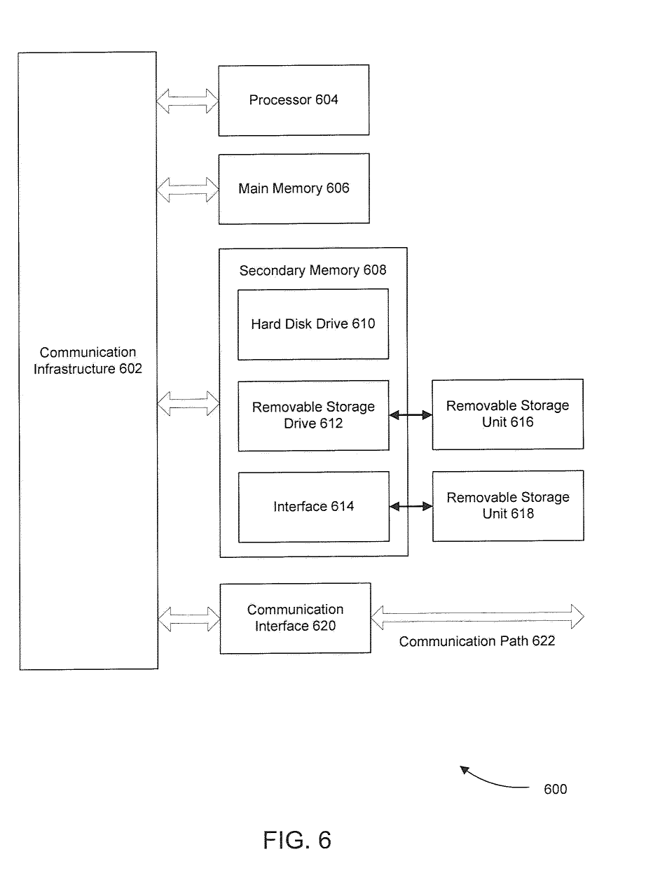

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 600 is shown in FIG. 6. Modules depicted in FIG. 4 may execute on one or more computer systems 600. Furthermore, each of the steps of the method depicted in FIG. 5 can be implemented on one or more computer systems 600.

Computer system 600 includes one or more processors, such as processor 604. Processor 604 can be a special purpose or a general purpose digital signal processor. Processor 604 is connected to a communication infrastructure 602 (for example, a bus or network). Various software implementations are described in terms of this exemplary computer system. After reading this description, it will become apparent to a person skilled in the relevant art(s) how to implement the disclosure using other computer systems and/or computer architectures.

Computer system 600 also includes a main memory 606, preferably random access memory (RAM), and may also include a secondary memory 608. Secondary memory 608 may include, for example, a hard disk drive 610 and/or a removable storage drive 612, representing a floppy disk drive, a magnetic tape drive, an optical disk drive, or the like. Removable storage drive 612 reads from and/or writes to a removable storage unit 616 in a well-known manner. Removable storage unit 616 represents a floppy disk, magnetic tape, optical disk, or the like, which is read by and written to by removable storage drive 612. As will be appreciated by persons skilled in the relevant art(s), removable storage unit 616 includes a computer usable storage medium having stored therein computer software and/or data.

In alternative implementations, secondary memory 608 may include other similar means for allowing computer programs or other instructions to be loaded into computer system 600. Such means may include, for example, a removable storage unit 618 and an interface 614. Examples of such means may include a program cartridge and cartridge interface (such as that found in video game devices), a removable memory chip (such as an EPROM, or PROM) and associated socket, a thumb drive and USB port, and other removable storage units 618 and interfaces 614 which allow software and data to be transferred from removable storage unit 618 to computer system 600.

Computer system 600 may also include a communications interface 620. Communications interface 620 allows software and data to be transferred between computer system 600 and external devices. Examples of communications interface 620 may include a modem, a network interface (such as an Ethernet card), a communications port, a PCMCIA slot and card, etc. Software and data transferred via communications interface 620 are in the form of signals which may be electronic, electromagnetic, optical, or other signals capable of being received by communications interface 620. These signals are provided to communications interface 620 via a communications path 622. Communications path 622 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 616 and 618 or a hard disk installed in hard disk drive 610. These computer program products are means for providing software to computer system 600.

Computer programs (also called computer control logic) are stored in main memory 606 and/or secondary memory 608. Computer programs may also be received via communications interface 620. Such computer programs, when executed, enable the computer system 600 to implement the present disclosure as discussed herein. In particular, the computer programs, when executed, enable processor 604 to implement the processes of the present disclosure, such as any of the methods described herein. Accordingly, such computer programs represent controllers of the computer system 600. Where the disclosure is implemented using software, the software may be stored in a computer program product and loaded into computer system 600 using removable storage drive 612, interface 614, or communications interface 620.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### V. CONCLUSION

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. An upstream transmitter configured to process data for upstream transmission to a cable modem termination system over a hybrid fiber coaxial (HFC) network, comprising:
a symbol mapper configured to map bits of the data to complex data symbols in accordance with a bit-loading parameter that specifies a number of bits per complex data symbol in a minislot of an upstream transmission burst; and
an orthogonal frequency-division multiple access (OFDMA) framer configured to place the complex data symbols in sub-carriers of the minislot and place pilots in the sub-carriers of the minislot in accordance with a pilot pattern parameter that specifies a pilot pattern,
wherein the bit-loading parameter and the pilot pattern parameter are associated with an upstream profile specified by the cable modem termination system for the minislot.

2. The upstream transmitter of claim 1, wherein the upstream profile is specified by the cable modem termination system in a grant message.

3. The upstream transmitter of claim 1, wherein the pilot pattern specified by the pilot pattern parameter is one pilot pattern among a plurality of pilot patterns defined within a communication specification in which the upstream transmitter is configured to operate in accordance with.

4. The upstream transmitter of claim 1, wherein the pilot pattern specified by the pilot pattern parameter is selected for the minislot based on a position of the minislot within the upstream transmission burst.

5. The upstream transmitter of claim 1, wherein the pilot pattern specified by the pilot pattern parameter is selected based on channel conditions associated with the minislot or based on whether pre-equalization is performed by the upstream transmitter to pre-equalize the sub-carriers of the minislot.

6. The upstream transmitter of claim 1, wherein the pilot pattern specified by the pilot pattern parameter is selected from among a plurality of pilot patterns that each use a different binary phase-shift keying (BPSK) pilot sub-carrier spacing configuration.

7. The upstream transmitter of claim 6, wherein the different BPSK pilot sub-carrier spacing configurations include placing a BPSK pilot on every: eighth sub-carrier, fourth sub-carrier, second sub-carrier, and every sub-carrier of an OFDM symbol.

8. The upstream transmitter of claim 1, wherein the bit-loading parameter specifies the number of bits per complex data symbol to be in the range of 6-10 bits per complex data symbol.

9. The upstream transmitter of claim 1, wherein the OFDMA framer is configured to place the complex data symbols in the sub-carriers of the minislot in accordance with a minislot dimension parameter that specifies a site of the minislot.

10. The upstream transmitter of claim 1, wherein the pilot pattern is a subslot pilot pattern.

11. A method for processing data for upstream transmission to a cable modem termination system over a hybrid fiber coaxial (HFC) network, comprising:
mapping bits of the data to complex data symbols in accordance with a bit-loading parameter that specifies a number of bits per complex data symbol in a minislot of an upstream transmission burst;
placing the complex data symbols in sub-carriers of the minislot; and
placing pilots in the sub-carriers of the minislot in accordance with a pilot pattern parameter that specifies a pilot pattern,
wherein the bit-loading parameter and the pilot pattern parameter are associated with an upstream profile specified by the cable modem termination system for the minislot.

12. The method of claim 11, wherein the pilot pattern specified by the pilot pattern parameter is one pilot pattern among a plurality of pilot patterns defined within a communication specification.

13. The method of claim 11, wherein the pilot pattern specified by the pilot pattern parameter is selected for the minislot based on a position of the minislot within the upstream transmission burst.

14. The method of claim 11, wherein the pilot pattern specified by the pilot pattern parameter is selected based on channel conditions associated with the minislot or based on whether pre-equalization is performed to pre-equalize the sub-carriers of the minislot.

15. The method of claim 11, wherein the pilot pattern specified by the pilot pattern parameter is selected from among a plurality of pilot patterns that each use a different binary phase-shift keying (BPSK) pilot sub-carrier spacing configuration.

16. The method of claim 15, wherein the different BPSK pilot sub-carrier spacing configurations include placing a BPSK pilot on every: eighth sub-carrier, fourth sub-carrier, second sub-carrier, and every sub-carrier of an OFDM symbol.

17. The method of claim 11, wherein the bit-loading parameter specifies the number of bits per complex data symbol to be in the range of 6-10 bits per complex data symbol.

18. The method of claim 11, wherein placing the complex data symbols in the sub-carriers of the minislot further comprises:
placing the complex data symbols in the sub-carriers of the minislot in accordance with a minislot dimension parameter that specifies a size of the minislot.

19. A method for processing data for upstream transmission to a cable modem termination system over a hybrid fiber coaxial (HFC) network, comprising;
mapping bits of the data to complex data symbols in accordance with a bit-loading parameter that specifies a number of bits per complex data symbol in a mini slot of an upstream transmission burst;
placing the complex data symbols in sub-carriers of the minislot; and
placing pilots in the sub-carriers of the minislot in accordance with a pilot pattern parameter that specifies a pilot pattern,
wherein the bit-loading parameter and the pilot pattern parameter are associated with an upstream profile specified by a cable modem termination system for the minislot, and
wherein the pilot pattern specified by the pilot pattern parameter is selected from among a plurality of pilot patterns that use a binary phase-shift keying (BPSK) pilot sub-carrier spacing of either eight, four, two, or one.

20. The method of claim 19, wherein the pilot pattern specified by the pilot pattern parameter is selected for the minislot based on a position of the minislot within the upstream transmission burst.
